(19) United States
(12) Patent Application Publication
(10) Pub. No.: US 2002/0050545 A1
(43) Pub. Date: May 2, 2002

(54) Boat guide

(76) Inventor: David Leonard Berry, Cibolo, TX (US)

Correspondence Address: David L. Berry, 122 Northview Cir., Cibolo, TX, 78108, US

(21) Appl. No.: 09/957,134

(22) Filed: Sep. 21, 2001

Related U.S. Application Data
(60) Provisional application No. 60/237,765, filed on Oct. 3, 2000.

(51) Int. Cl. F16M 11/00

(52) U.S. Cl. 248/127; 248/166

(57) ABSTRACT

A front support for use on a trailer to aid in guiding a boat onto the trailer. The front support is a two section V-shaped support adjustable for various boats. The V-shaped support has angle supports connected to L-brackets. The L-brackets are in turn connected at one point to vertical supports and at another point to central support brackets. The vertical supports and central support brackets connect to the trailer.

### BACKGROUND OF THE INVENTION

The present invention relates to a front support for use on a trailer to aid in guiding a boat on to the trailer.

### SUMMARY OF THE INVENTION

It is a primary object of the present invention to provide novel boat guide.

It is another object of the present invention to provide a novel boat guide for use with a trailer.

Another object of the present invention is to provide a novel boat guide that prevents the front of a boat from drifting from side to side when the boat is being loaded on the trailer.

Yet another object of the present invention is to provide a novel boat guide that has a V-shape.

Still another object of the present invention is to provide a novel boat guide that can be adjusted to the form of any boat.

### BRIEF DESCRIPTION OF THE DRAWINGS

FIG. 1 is a perspective view of a boat being loaded onto a trailer utilizing the preferred embodiment of the present invention.

FIG. 2 is a front view of the preferred embodiment of the present invention.

FIG. 3 is an exploded view of the preferred embodiment of the present invention.

### DETAILED DESCRIPTION OF THE PREFERRED EMBODIMENT

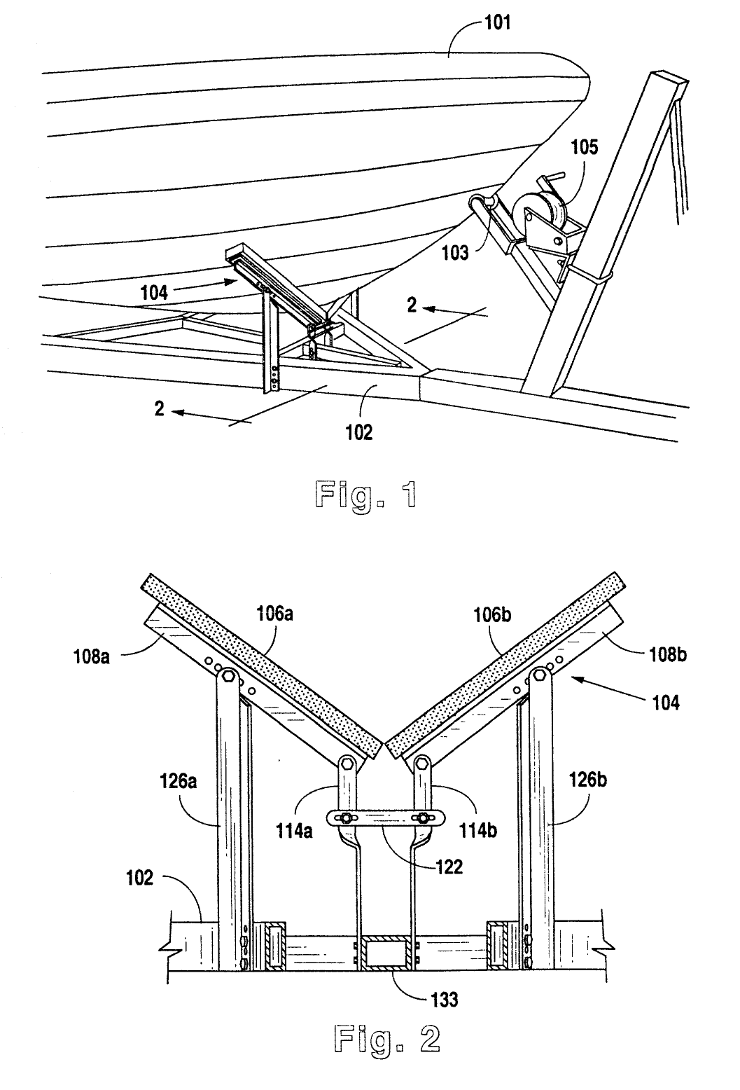

In FIG. 1, a perspective view of a boat being loaded onto a trailer utilizing the preferred embodiment of the present invention is shown. When a boat 101 is loaded onto a traditional trailer 102, the boat 101 has a tendency to drift from side to side as it approaches the front roller 103 to be hooked into place. In order to alleviate this drifting, the preferred embodiment of the present invention provides for a novel boat guide that has a V-shaped support 104. The V-shaped support 104 is mounted towards the front of the trailer 102. With the V-shaped support 104 in place, an operator can drive the boat 101 onto the trailer 102 all the way up to the pulley 105.

FIG. 2 illustrates a front view of the preferred embodiment of the present invention. A V-shaped support 104 is shown having left and right angle supports 106a and 106b respectively in direct contact with a left L-bracket 108a and a right L-bracket 108b. The left L-bracket 108a is connected at one point to a left vertical support 126a. The opposite end of the left vertical support 126a is connected to a trailer 102. A left central support bracket 114a is connected at one end of the left L-bracket 108a. The opposing end of the left central support bracket 114a is connected to one side of a central frame block 133 of a trailer 102. The right L-bracket 108b is connected at one point to a right vertical support 126b. The opposite end of the right vertical support 126b is connected to a trailer 102. A right central support bracket 114b is connected at one end of the right L-bracket 108b. The opposing end of the right central support bracket 114b is connected to the opposite side of a central frame block 133 of a trailer 102. The left central support bracket 114a and the right central support bracket 114b are connected by way of a horizontal member 122.

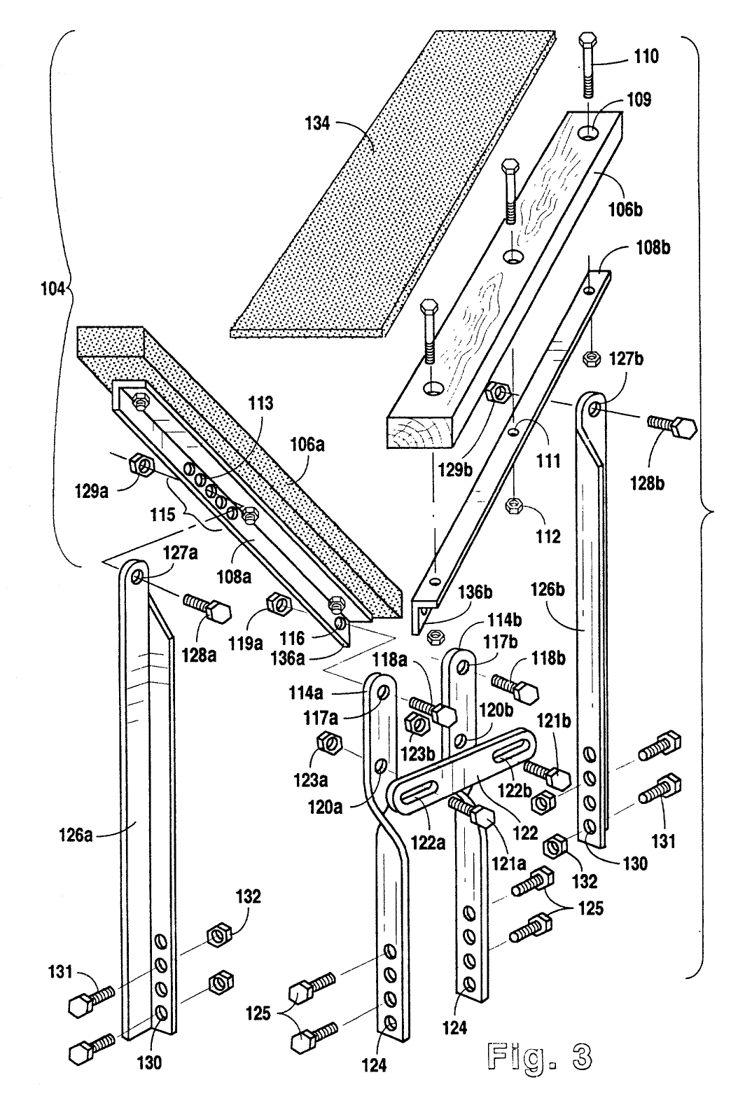

In FIG. 3 an exploded view of the preferred embodiment of the present invention is shown. A V-shaped support 104 is shown. The V-shaped support 104 is composed of several components. The portion of the V-shaped support 104 in direct contact with boat 101 has a left angle support 106a and a right angle support 106b. The left angle support 106a and the right angle support 106b come together at an angle of 115°. The left angle support 106a and the right angle support 106b are both preferably rectangular in configuration having preferably dimensions of 1½ inches by 3½ inches by 21 inches and preferably made of wood. In addition, the angle supports 106a and 106b are preferably covered in carpet 134, preferably from a rectangular sheet having dimensions of 6½ inches by 25 inches.

Below left angle support 106a and right angle support 106b are a left L-shaped bracket 108a and a right L-shaped bracket 108b respectively. Both L-shaped brackets 108a and 108b preferably have a length of 21 inches and thickness of ¼ inch with a width of 1½ inches for each leg of L-brackets 108a and 108b.

There are preferably bolt holes 109 through the thickness of the angle support 106a and right angle support 106b, and most preferably three bolt holes 109 spaced equally apart and preferably 7½ inches apart. Within these bolt holes 109 are inserted bolts 110 of proper threading and dimension to situate within bolt holes 109. As the bolts 110 are threaded through left angle support 106a and right angle support 106b, the lower portion of bolt 110 is threaded into a corresponding hole 111 located along the length of one leg of the corresponding L-bracket 108a and 108b. Nuts 112 are threaded onto the bolts 110 on the opposing side of L-bracket 108a and 108b. On the second leg of both L-brackets 108a and 108b are a plurality of holes 113, preferably a linear group of five holes 115 spaced equidistance apart located approximately ⅓ down the length of the second leg from one end of the L-bracket 108a and 108b and a single hole 116 located at the opposing end. Both left L-bracket 108a and right L-bracket 108b are preferably made of 1½ inches by 1½ inches by ¼ inch aluminum or galvanized steel.

Extending at an angle of preferably 32° down from left L-bracket 108a is a left central support bracket 114a and extending at an identical angle down from right L-bracket 108b is a right central support bracket 114b. The central support brackets 114a and 114b are preferably generally rectangular being rounded at one end, squared off at the other end, and preferably have dimensions of 11 inches in length, 1½ inches in width, and ¼ inch in thickness made from preferably aluminum or galvanized steel. At the upper most portion of left central support bracket 114a is hole 117a through which is inserted bolt 118a; a similar hole 117b is located at the upper most portion of right central support bracket 114b through which is inserted bolt 118b. Once bolts 118a and 118b are inserted through the respective holes 117a and 117b, the bolts 118a and 118b are fed through the respective holes of 116a and 116b of the second leg of L-brackets 108a and 108b and are held in place by nuts 119.

Located, preferably 8 inches, below holes 117a and 117b of central support brackets 114a and 114b are holes 120a and 120b respectively. Bolts 121a and 121b feed through opposing holes 122a and 122b of a horizontal member 122. Horizontal member 122 is preferably elongate oval in shape having a length of 6 inches, a width of 1½ inches and a thickness of ¼ made from aluminum or galvanized steel. In addition, horizontal member 122 preferably has holes 122a and 122b that are elongate oval having dimensions of ⅜ inch by 2 inches by ¼ inch. Holes 122a and 122b are preferably spaced 4 inches apart from center. Once bolts 121a and 121b are fed through the respective opposing holes 122a and 122b of horizontal member 122, bolts 121a and 121b are fed respectively through holes 120a and 120b and held in place by respective nuts 123a and 123b. The central support brackets 114a and 114b are preferably twisted at approximately ⅓ their length creating a flat surface at the upper portion of central support brackets 114a and 114b with a plane along the y-axis and creating a flat surface at the lower portion of central support brackets 114a and 114b with a plane along the z-axis. The distance between the upper portion of central support brackets 114a and 114b is preferably 3 inches.

At the opposite end of central support brackets 114a and 114b are a plurality of holes 124, preferably four linear holes each for left central support bracket 114a and right central support bracket 114b spaced equidistant apart. On the outer sides of holes 124 are inserted bolts 125. When the central support brackets 114a and 114b are placed over central frame block 133 of a trailer 102 bolts 125 can be tightened to hold the central portion of the preferred embodiment of the present invention in place. The angle between the V-shaped support 104a and 104b can be adjusted to conform to the applicable boat 101. This adjustability is available due to the plurality of holes 113 located along the length of both L-shaped brackets 108a and 108b and a pivot connection 136a and 136b. The pivot connection 136a and 136b is provided for at the base of the L-shaped brackets 108a and 108b by virtue of the placement of the central support brackets 114 with bolts 118 there through and nuts 119 that can be loosened and tightened in coordination with the repositioning of the L-shaped brackets 108a and 108b as the vertical supports 126 are fed into the appropriate hole 113 of the L-shaped brackets 108a and 108b.

From one of the five holes 115 of the second leg of L-shaped brackets 108a and 108b are attached vertical supports 126a and 126b. The angle created between the second leg of L-shaped brackets 108a and 108b and the vertical supports 126a and 126b is preferably 32.5°. At the upper portion of the first leg of vertical supports 126a and 126b are holes 127a and 127b respectively. Through these holes 127a and 127b are inserted bolts 128a and 128b. Bolts 128a and 128b are then inserted through holes 115a and 115b respectively and held in place with nuts 129a and 129b. Vertical supports 126a and 126b are specially designed L-brackets having one leg preferably generally rectangular being rounded at one end and squared off at the opposing end and having preferably approximate dimensions of 1½ inches by 1½ inches by ¼ inch. The other leg of vertical supports 126a and 126b is preferably generally rectangular having an angular cut at one end with an angle of 45° from zero. The opposing end of the second leg is preferably squared off. The dimensions of the second leg are preferably 16 inches by 1½ inches by 1½ inches at its furthest point. Vertical supports 126a and 126b are preferably made from aluminum or galvanized steel. At the opposing end of the second leg of vertical supports 126a and 126b are a plurality of holes 130, preferably four placed in a row equidistant apart through which are inserted bolts 131. Once inserted through holes 130, bolts 131 are bolted into the outer frame of trailer 102 and held in place with nuts 132.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention.

1. I claim that my invention is a device that guides the front of a boat to the front stop of a boat trailer while loading on its trailer

2. I claim that my invention is a device that centers the front of a boat on its trailer when loading the boat.

3. I claim that my invention has no moving parts when installed on a boat trailer.
